(19) United States
(12) Patent Application Publication
(10) Pub. No.: US 2010/0260949 A1
(43) Pub. Date: Oct. 14, 2010

(54) SYNTHETIC SILICA GLASS TUBE FOR THE PRODUCTION OF A PREFORM

(75) Inventors: Oliver Ganz, Bruchkoebel (DE); Ralph Sattmann, Aschaffenburg (DE); Jan Vydra, Hanau (DE)

Correspondence Address: TIAJOLOFF & KELLY, CHRYSLER BUILDING, 37TH FLOOR, 405 LEXINGTON AVENUE, NEW YORK, NY, 10174, US

(73) Assignee: HERAEUS QUARZGLAS GMBH & CO. KG, Hanau (DE)

(21) Appl. No.: 12/820,001

(22) Filed: Jun. 21, 2010

Related U.S. Application Data
(62) Division of application No. 10/550,049, filed on Sep. 21, 2005.

(30) Foreign Application Priority Data
Mar. 21, 2003 (DE) 103 12 760.7
Mar. 22, 2003 (DE) 103 12 543.4

(51) Int. Cl. B32B 1/08; C03C 15/00

(52) U.S. Cl. 428/34.1; 65/30.13

(57) ABSTRACT

Known synthetic quartz glass tubes for the production of a preform have an inner bore with a surface layer produced without using tools in the molten state and an inner zone. The aim of the invention is to provide a tube which does not release any OH groups to the surroundings. For this purpose, the surface layer (30) has a thickness of 10 μm and an average OH content of not more than 5 ppm by weight and an average surface roughness Rₐ of not more than 0.1 μm. The inner zone (34) that starts on the surface layer (30) and terminates 10 μm before the outer wall has an average OH content of not more than 0.2 ppm by weight. A simple and inexpensive method for producing a quartz tube of the above type is to continuously draw a tube strand from a softened quartz glass mass in a vertical drawing process. A scavenging gas is circulated through the inner bore of the tube, said gas having a water content of less than 100 ppb per weight. The front end of the tube strand (19) is closed by a flow obstacle (26) that is permeable the scavenging gas and that reduces the amount of scavenging gas (23) flowing through.

The present invention relates to a tube of synthetic silica glass for the production of a preform, the tube having an inner bore with a surface layer produced without tool-contact in the molten state, an outer cylinder wall and an inner region extending between inner bore and outer cylinder wall.

Furthermore, the present invention relates to a method for producing a tube of synthetic silica glass in a vertical drawing method in that a silica glass mass is continuously supplied to a heating zone and softened therein, and a tube strand is continuously drawn off from the softened region and a scavenging gas is circulated through the inner bore of the tube and a silica glass tube is obtained therefrom by being cut to length.

Furthermore, the present invention relates to an appropriate use of the silica glass tube.

In the so-called MCVD method (modified chemical vapor deposition) for producing preforms for optical fibers, layers of SiO₂ and of doped SiO₂ are deposited from the gas phase, as is generally known, on the inside of a so-called substrate tube of pure silica glass. The internally coated substrate tube, including the layers deposited therein, is subsequently collapsed and drawn into a fiber. As a rule, additional cladding material is applied before or during fiber drawing.

When light is propagated, the light modes are not only guided in the core of the fiber but also in the cladding region. Although the intensity proportion guided in the cladding region decays exponentially to the outside, depending on the fiber design, it must be ensured that no contaminants are contained therein that would cause a high additional attenuation in the range of the wavelengths intended for optical transmission.

A silica glass tube and a method for its production according to the above-mentioned type are described in DE 198 52 704 A1. The known method starts with the production of a soot tube by producing SiO₂ particles by flame hydrolysis of SiCl₄ and by depositing the particles in layers on a rotating carrier, resulting in a porous SiO₂ soot tube. For reducing the hydroxyl groups to a value of less than 30 wtppb, the soot tube produced in this way is subjected to a chlorine treatment at an elevated temperature and is then vitrified, thereby forming a hollow cylinder of synthetic silica glass. The surfaces of the hollow cylinder are mechanically smoothed and chemically etched. The hollow cylinder pretreated in this way is then elongated to a final dimension of the substrate tube. A soot tube is thereby obtained that is characterized by high purity and by a smooth inner surface produced without tool-contact in the molten state, said inner surface being particularly suited for a subsequent inner coating in the MCVD method.

Although the substrate tubes that are commercially available at the moment consist of synthetically produced silica glass of a high purity, they contain contaminants. When high demands are made on the attenuation properties of the optical fiber, they are therefore only suited to a limited degree as a cladding material directly surrounding the core portion. As a rule, an inner cladding region of utmost purity is therefore first deposited on the inner wall of the substrate tube and it is only thereafter that the layers for the later core region will be deposited. When the substrate tube is collapsed into a core rod and during subsequent drawing of the fibers, high temperatures are however reached, on account of which contaminants might diffuse from the substrate tube into the inner cladding region and even into the core region. Hydrogen and above all OH ions have turned out to be particularly critical. The harmful effect of hydrogen, which easily diffuses into the SiO₂ matrix, consists in that it can recombine with matrix oxygen, thereby forming OH⁻ radicals.

To mitigate said problem, it is suggested in CA 2,335,879 A1 that an additional diffusion barrier layer which contains phosphorus pentoxide should be produced on the inside of the substrate tube. The diffusion barrier layer is to prevent OH ions from diffusing out of the substrate tube into the inner cladding region. This procedure, however, is relatively complicated.

It is also known that the inner surface of the substrate tube is removed, e.g. by mechanical milling, by chemical etching or by plasma etching. Although part of the impurities contained on or in the surface layer is removed, said method is relatively slow and other contaminants or surface defects may be created. Selective etching processes have a particularly harmful effect. Especially with long etching periods, these processes result in uneven removal and thus in damage to the surface and destroy the advantageous surface structure produced in the molten state and may therefore have an adverse effect on the further MCVD process.

Moreover, all of the removal methods basically suffer from the problem that the thickness of the contaminated surface layer to be suitably removed may vary from case to case and is not exactly known as a rule.

It is therefore the object of the present invention to provide a tube of synthetic silica glass with a surface produced without tool-contact, which tube does not show the above-mentioned drawbacks with respect to the release of OH groups, and to indicate a simple and inexpensive method for producing such a silica glass tube.

As for the silica glass tube, said object starting from the above-mentioned silica glass tube is achieved according to the invention in that the surface layer has a thickness of 10 μm and a mean OH content of not more than 5 wtppm and an average surface roughness Rₐ of not more than 0.1 μm therein, and that the inner region which starts on the surface layer and terminates 10 μm before the outer cylinder wall has a mean OH content of not more than 0.2 wtppm.

It has been found that when the known silica glass tubes are used, and despite a nominally low OH content, problems may arise that as such can only be ascribed to an increased OH content. The nominal OH content of the silica glass tube is usually determined by spectroscopy through measurement over the wall thickness. It has now been found that in this measuring method the OH groups contained in the surface layer are hardly noticed even if present in a thin surface layer at a high concentration.

If not explicitly stated otherwise, the following observations made on the surface layer refer to the layer adjoining the inner bore of the silica glass tube, which is particularly critical for preform production and particularly for the MCVD method. The silica glass tube consists of the inner region which extends between the surface layer and the outer cylinder wall. The inner region is a region having comparatively homogeneous properties of the material, which at both sides is defined by outer cylinder walls which may contain contaminants near the surface. To exclude such surface-near contaminants in the definition of the inner region, a thickness of 10 μm of the respective surface (of the inner wall and the outer cylinder wall, respectively) is each time added. The inner region will also be called “bulk” in the following.

The silica glass tube of the invention shows three essential aspects:
1. On the one hand, it shows a low OH content of not more than 0.2 wtppm in the bulk material, preferably not more than 0.1 wtppm. Absorption by OH groups is thereby avoided and light modes with intensities in the cladding region are consequently attenuated less strongly.
The information on the OH content in the bulk refers to a mean OH content which is determined by spectroscopy.
2. Moreover, the surface layer has a low mean OH content down to a depth of 10 μm. In the surface layer, OH groups may be formed in the course of silica glass tube production. These are normally only weakly bonded to the SiO₂ network and may pass into optically more efficient fiber regions due to high temperatures during fiber drawing and may thus contribute to fiber attenuation. The content of such weakly bonded OH groups in the surface layer is kept as low as possible, but at any rate so low that a mean OH content of not more than 5 wtppm, preferably not more than 1 wtppm, is obtained in the surface layer.
A mechanical or chemical removal of the surface layer, as has been explained above, is thus not needed, so that the associated efforts and the above-explained drawbacks with respect to possible surface changes are avoided. The OH content in the surface layer is also determined by spectroscopy, namely by differential measurement.
3. The aspect of the inventive silica glass tube as explained under 2. permits the use of a silica glass tube for preform production that has a surface produced without tool-contact in the molten state. It is particularly suited for the inner deposition of SiO₂ layers by means of the MCVD method. The surface layer of the silica glass tube of the invention is produced in a drawing process. Such a surface layer is substantially characterized by a low surface roughness and is defined in the sense of the present invention by an Rₐ value of not more than 0.1 μm. The definition of the surface roughness Rₐ follows from EN ISO 4287/1.
The silica glass tube may be produced in a crucible drawing process or by elongation of a hollow cylinder.

As for the production of complex radial refractive index profiles, the synthetic silica glass is preferably doped with a dopant in the form of fluorine, GeO₂, B₂O₃, P₂O₅, Al₂O₃, TiO₂, or a combination of said dopants.

As for the method, the above-indicated object, starting from the above-indicated method; is achieved according to the present invention in that a scavenging gas is used with a water content of less than 100 wtppb and that the front end of the tube strand is closed by a flow obstacle which is permeable to the scavenging gas and which reduces the amount of the scavenging gas flowing therethrough.

In the method of the invention, a scavenging gas is continuously circulated through the inner bore of the drawn-off tube strand. It has been found that deposits are thereby prevented on the inner wall and that even contaminants can be discharged.

On the other hand, a scavenging gas having a water content of less than 100 wtppb is used according to the invention, so that the scavenging process itself hardly introduces any hydroxyl ions into the silica glass of the inner wall.

A continuous scavenging process is guaranteed in that a scavenging gas is introduced into the inner bore and can escape at the lower end of the tube strand. The unhindered free escape of the scavenging gas from the inner bore, however, is prevented according to the invention in that the front end of the tube strand is closed by a flow obstacle which is permeable to the scavenging gas. In the vertical drawing process without any tools, the pressure difference between the internal pressure prevailing in the inner bore and the external pressure acting from the outside is an important parameter for process control. In process control, said pressure difference or the internal pressure is e.g. used for controlling the tube wall thickness or the tube diameter. The internal pressure is predominantly defined by the flow volume of the scavenging gas. With a free outflow, a high gas throughput is needed for adjusting a predetermined internal pressure. In comparison with a procedure without a flow obstacle, the flow obstacle provided according to the invention reduces the gas throughput of high-purity scavenging gas needed for process control, and it therefore has a cost-reducing effect. The flow obstacle consists in a gaseous, liquid or solid plug which partly closes the inner bore, or in a constriction of the inner bore.

Preferably, a scavenging gas is used having a water content of less than 30 wtppb.

The lower the water content of the scavenging gas is the lower is the entry of OH groups into the surface of the inner wall of the tube strand.

As for the flow obstacle, it has turned out to be useful when said obstacle is formed by a plug projecting into the inner bore of the tube strand, the plug narrowing the cross section of freely flowing scavenging gas.

The plug projects, for instance, from the free front end of the tube strand into the inner bore, preferably up to above the region in which the silica glass tube is cut to length. The cutting to length of the tube strand can at the most produce insignificant variations in process control. The plug is made from a porous material, or it has at least one continuous opening.

As an alternative, which is equally preferred, the flow obstacle is formed by a gas curtain acting on the front end of the tube strand.

For producing the gas curtain a high-purity gas is used so that there are no contamination problems arising in the region of the inner bore. Moreover, this procedure is characterized by easy handling. A gas curtain is achieved by a gas stream in a direction transverse to the longitudinal axis of the drawn-off tube strand. It produces pressure acting against the outflowing scavenging gas, thereby reducing the flow of the scavenging gas therethrough.

As for the economy of the method, it has turned out to be advantageous when the silica glass mass is provided in the form of a hollow cylinder which, starting with its front end, is continuously supplied to the heating zone and softened therein in portions and the tube strand is continuously drawn off from the softened region, the hollow cylinder being elongated to at least 5 times, preferably at least 20 times, its initial length.

Elongation of a large-volume hollow cylinder of silica glass in the vertical drawing process permits not only an inexpensive production of tubes, but also yields the desired inner surface formed without tool-contact in the molten state. With an increasing elongation ratio between hollow cylinder and tube, the desired surface quality can be adjusted more easily.

It has turned out to be particularly advantageous when the scavenging gas contains a gaseous drying agent, particularly a chlorine-containing gas.

The gaseous drying agent is normally constituted by halogen-containing, particularly chlorine-containing, substances. These react with residual water in the scavenging gas and surface layer, thereby effecting a particularly efficient drying of the inner surface of the tube.

Moreover, it has turned out to be advantageous when prior to introduction into the inner bore of the tube strand the scavenging gas is subjected to a drying process.

The drying process effects a separation of the scavenging gas from the water contained therein and from other harmful substances, such as hydrocarbons, by mechanical or chemical means. The mechanical means comprise, for instance, the introduction of the scavenging gas into a suitable filter in which water molecules are retained.

Preferably, the volume flow of the scavenging gas through the inner bore is not more than 80 l/min (standard liter/min).

The hotter the inner wall of the tube strand is the smoother is the desired surface produced in the molten state. The scavenging gas, however, may effect a cooling of the inner bore, which impairs the formation of the desired smooth surface. It has been found that said cooling effect can be kept in a volume flow of up to 80 l/min still so low that the surface quality is not deteriorated in a noticeable way. To achieve such a condition, the use of a flow obstacle is imperative in the inner bore, as has been explained above, in consideration of the internal pressure which is predetermined by the process control and has to be maintained.

An external scavenging gas preferably flows around the outer cladding of the tube strand in the region of the heating zone, the scavenging gas being used as the external scavenging gas.

In this case the scavenging gas flowing around the outer cylinder wall of the tube strand is the same as the one flowing around the inner wall. As a result, the outer cylinder wall is hardly charged with OH groups, which yields a silica glass tube that has a low OH content both in the inner bore and on the outer cylinder wall.

Depending on the use intended for the silica glass tube, smaller demands can be made on the quality in the region of the outer cylinder wall than on the quality of the inner wall. In such cases it has turned out to be particularly advantageous when an external scavenging gas flows around the outer cylinder wall of the tube strand in the region of the heating zone, the water content of the scavenging gas being lower by at least the factor 10 than the water content of the external scavenging gas.

Thanks to the use of an external scavenging gas making small demands on purity in comparison with scavenging gas, the consumption costs can be reduced. When an external scavenging gas is used, it has turned out to be particularly useful when said gas flows around the outer cladding of the tube strand at least for such a long time that the cladding is cooled down to a temperature below 900° C.

It is thereby prevented that at high temperatures the outer cladding gets into contact with water-containing atmosphere, such as air. At temperatures above 900° C., an incorporation of OH groups into the silica glass matrix might have to be expected to a significant degree. The external scavenging gas can here also contribute to a faster cooling of the outer cladding of the tube strand.

It has also turned out to be particularly advantageous when the silica glass tube is additionally subjected to an OH reduction treatment at a temperature of at least 900° C. in water-free atmosphere or in vacuum.

Thanks to the OH reduction treatment the OH content in the surface region can be reduced later both on the inner wall and on the outer cylinder wall.

In this respect it has turned out to be particularly advantageous when the OH reduction treatment comprises a treatment in deuterium-containing atmosphere.

In such an OH reduction treatment, existing OH groups are replaced by OD groups which do not produce any absorption bands in the wavelength range as is presently used for optical data transmission.

The silica glass tube of the invention and the silica glass tube produced according to the method of the invention are particularly suited as a substrate tube for internal deposition of SiO₂ layers in an MCVD method.

The present invention will now be explained in more detail with reference to embodiments and a drawing. The drawing shows in detail in

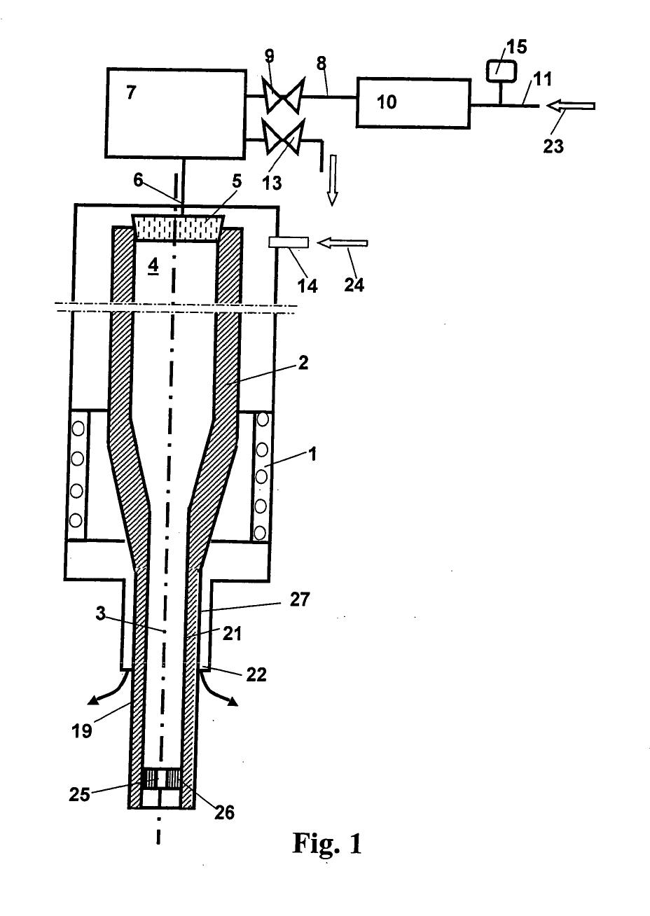

FIG. 1 a schematic representation of an embodiment for producing a substrate tube by elongating a hollow cylinder of silica glass into a silica glass tube in a vertical drawing method;

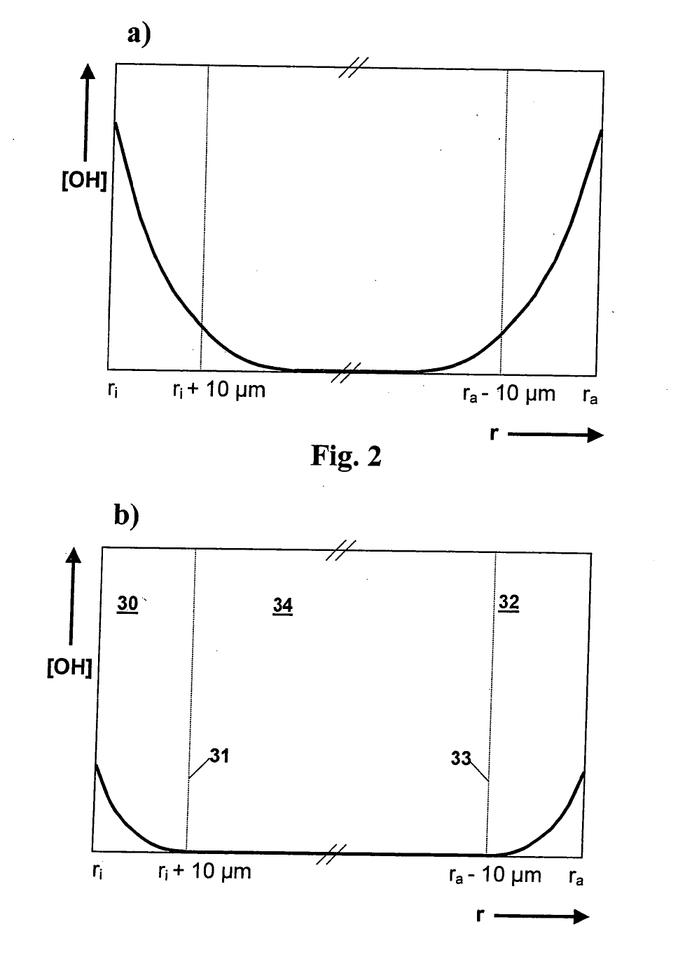

FIG. 2 diagrams illustrating the profile of the OH content over the wall of differently produced substrate tubes in a schematic representation, namely in FIG. 2a in a substrate tube produced according to the prior art, and in FIG. 2b in a substrate tube produced according to the present invention.

FIG. 1 shows an embodiment of the method of the invention and an apparatus suited for performing the method. The apparatus comprises a vertically arranged furnace 1 which can be heated to temperatures above 2300° C. and comprises a heating element of graphite.

A hollow cylinder 2 of synthetic silica glass is introduced with a vertically oriented longitudinal axis 3 from above into the furnace 1. The inner bore 4 of the hollow cylinder 2 is upwardly closed by a plug 5. A scavenging gas line 6 is introduced through the plug 5 into the inner bore 4. The scavenging line 6 terminates in a process container 7 which is connected via a gas line 8, which can be closed by means of a shut-off valve 9, and via a filter 10 (“Hydrosorb” of Messer Griesheim GmbH) to a nitrogen line 11 which is provided with a flow meter and control device 15. A nitrogen stream is passed via lines 6, 8, 11 into the inner bore 4, the supply thereof being symbolized by directional arrow 23. The water content of the nitrogen stream introduced into the inner bore 4 is 10 wtppb.

For compensating pressure variations the process container 7 is additionally provided with a bypass valve 13 which can be opened and closed. In the opened state, part of the gas constantly flows off from the process container 7, so that sudden changes in the flow conditions caused by a control action or due to other reasons has only a partial effect on pressure variations in the process container 7.

The lower front end 19 of the tube strand 21 is closed by means of a plug 26 which has a central through hole 25 with a diameter of 4 mm. The flow of the nitrogen stream 23 is reduced by means of the plug 26 to about 30 standard liter/min, depending on the setting by the process control.

To prevent oxidation in the furnace region, particularly melting loss of the graphite heating element and other graphite parts inside the furnace 1, the furnace is surrounded by a housing 14 which comprises an inlet for a nitrogen stream 24 and an outlet 22 by which the space between hollow cylinder 2 and inner wall of the furnace is continuously scavenged. The nitrogen stream 24 has the same quality as the nitrogen stream 23 and the two nitrogen streams 23, 24 are taken from the same source.

The outlet 22 forms the end of a cooling path 27 which extends in the manner of a sleeve as part of the housing 14 over a length of 1 meter from the bottom side of the furnace 1 and within which the nitrogen stream 24 flows along the outer cladding of the drawn-off tube strand 21. The length of the cooling path 27 is here configured such that the tube strand 21 has a temperature of only about 600° C. in the area of the outlet 22 when exiting into air. The low surface temperature prevents the incorporation of OH groups into the silica glass.

A procedure typical of the method of the invention shall now be described in more detail with reference to FIG. 1:

The hollow cylinder 2 has an outer diameter of 150 mm and a wall thickness of 40 mm. After the furnace 1 has been heated up to its desired temperature of about 2300° C., the hollow cylinder 2 is moved with the lower end 19 from above into the furnace 1 and is softened at a position approximately in the middle of the furnace 1. At the same time the lower end 19 of the hollow cylinder 2 is withdrawn from the furnace 1 in that a detaching first glass mass plug is gripped and removed by being drawn off. The hollow cylinder 2 is subsequently lowered continuously at a lowering speed of 11 mm/min and the softened end 19 is removed by being drawn off at a rate of 640 mm/min to form a tube strand having an inner diameter of 22 mm and an outer diameter of 28 mm.

In the drawing process, the nitrogen stream 23 dried in filter 10 is introduced via the scavenging gas line 6 into the inner bore 4. Before being introduced into the filter, the nitrogen stream 23 has a purity class 4.0 (≧99.99%) and thereafter shows a residual moisture of 10 wtppb.

Contaminants are discharged by the nitrogen stream 23 in the area of the inner wall of the inner bore 4. The incorporation of OH groups into the hot silica glass of the inner wall of the tube strand is however kept as small as possible because of the very low water content of 10 wtppb.

Approximately atmospheric pressure prevails in the interior of the furnace. The flow of the nitrogen stream 23 is set by means of the flow meter and control device 15 to about 30 standard liter/min, so that a substantially constant internal pressure of 3 mbar is set in the inner bore 4. During the drawing process the internal pressure is measured continuously and the flow of the nitrogen stream 23 is readjusted accordingly. The comparatively low flow rate of 30 l/min is made possible by using plug 26 as said plug impedes a free outflow of the nitrogen stream 23. This, in turn, has the consequence that an excessive cooling of the inner wall of the drawn-off silica glass tube by the gas stream is avoided and a smooth molten surface is obtained, as will be described in more detail further below with reference to FIG. 2.

Outer diameter and wall thickness of the drawn-off tube strand 21 are controlled by way of the process control. The internal pressure inside the inner bore 4 is used as the control variable, the pressure, in turn, being substantially the result of the nitrogen stream 23, so that in case of dimensional variations the amount of the nitrogen stream 23 is controlled by means of a control unit.

During the drawing process the bypass valve 13 is opened so that part of the nitrogen stream 23 will flow via the valve 13 to the outside and not into the inner bore 4 of the glass tube 21. Pressure variations in the inner bore 4 are thus attenuated. In the closed state of the bypass valve 13, the required amount of the nitrogen stream 23 is reduced by about 50%.

The resulting glass tube 21 is cut to suitable pieces and used as a substrate tube for depositing SiO₂ layers on the inner wall by means of an MCVD method. The substrate tube which has an average surface roughness Rₐ of 0.06 μm will be described in more detail in the following with reference to FIG. 2.

Each of the diagrams of FIG. 2 is a schematic illustration showing the profile of the OH concentration over the wall thickness of a substrate tube. FIG. 2a shows the profile in a substrate tube which has been obtained according to the prior art, and FIG. 2b the profile in a substrate tube according to the invention.

The OH content is each time plotted in relative units on the y-axis and the radius over the wall thickness of the substrate tube on the x-axis. rᵢ designates the inner wall, rₐ the outer wall of the substrate tube. A surface layer 30 in the area of the inner wall at a thickness of 10 μm (rᵢ+10 μm) is each time schematically outlined by a dotted line 31 and a surface layer 32 in the area of the outer wall at a thickness of 10 μm (rₐ−10 μm) by a dotted line 33. An inner region 34 having a thickness of about 3.0 mm extends between the surface layers 30 and 32.

FIG. 2a) shows that the OH content in the substrate tube produced according to the standard method, starting on the respective walls from a high level, decreases towards the interior in the region of the surface layers 30 and 32. The mean OH content in the region of the surface layers 30 and 32 is 7.4 wtppm in each case and 0.08 wtppm in the inner region 34. The relatively high OH content in the region of the surface layers 30 and 32 is hardly noticed in a spectroscopic measurement in which the whole substrate tube wall is radiographed. The mean OH content of the surface layers 30 and 32 is determined by spectroscopic differential measurements.

In comparison with FIG. 2a), the substrate tube of the invention according to FIG. 2b) shows a mean OH content in the inner region 34 of also about 0.08 wtppm, but a clearly lower OH content in the region of the surface layers 30 and 32. A mean value of 0.8 wtppm is there determined by spectroscopic differential measurement for the OH content. The substrate tube of the invention is therefore particularly suited for an application for producing layers near the fiber core by means of the MCVD method.

1. A tube of synthetic silica glass for producing a preform, said tube comprising a cylinder body of silica glass which has an inner bore and an inner peripheral surface facing said inner bore produced without tool-contact in a molten state, an outer cylinder wall, and an inner region extending between said inner bore and said outer cylinder wall, wherein a surface region having a thickness of 10 μm extending from the inner peripheral surface has a mean OH content of not more than 5 wtppm and the inner peripheral surface has an average surface roughness Rₐ of not more than 0.1 μm, and the inner region extending from the inner bore and terminating 10 μm before the outer cylinder wall, said inner region having a mean OH content of not more than 0.2 wtppm.

2. The silica glass tube according to claim 1, wherein the mean OH content in the surface region is not more than 1 wtppm.

3. The silica glass tube according to claim 1, wherein the mean OH content in the inner region is not more than 0.1 wtppm.

4. The silica glass tube according to claim 1, wherein the synthetic silica glass is doped with a dopant selected from the group consisting of fluorine, GeO₂, B₂O₃, P₂O₅, Al₂O₃, and TiO₂, or with a combination of two or more of said dopants of said group.

5.-18. (canceled)

19. A method of forming a tubular glass member, said method comprising: forming a silica glass tube according to claim 1, and depositing SiO₂ layers on the inner peripheral facing said inner bore using MCVD with said silica glass tube being used as a substrate tube for said MCVD.

20.-21. (canceled)
